(19) United States
(12) Patent Application Publication
(10) Pub. No.: US 2008/0206474 A1
(43) Pub. Date: Aug. 28, 2008

(54) Stabilization and Performance of Autocatalytic Electroless Processes

(75) Inventor: Anders Remgard, Molndal (SE)

Correspondence Address: HARNESS, DICKEY & PIERCE, P.L.C., P.O. BOX 8910, RESTON, VA, 20195, US

(73) Assignee: POLYMER KOMPOSITER I GOTEBORG AB, Molndal (SE)

(21) Appl. No.: 11/791,512

(22) PCT Filed: Dec. 13, 2005
(86) PCT No.: PCT/SE2005/001930

§ 371 Date: Dec. 28, 2007

(30) Foreign Application Priority Data
Dec. 14, 2004 (SE) 0403042-5

(51) Int. Cl. B05D 1/18; B32B 15/04; C04B 41/51

(52) U.S. Cl. 427/443.1; 428/457; 106/1.19; 106/1.14

(57) ABSTRACT

Disclosed is a method of plating a substrate with a metal using an autocatalytic electroless plating bath wherein the bath is operated above its cloud point temperature such that at least two phases are present in the bath. An autocatalytic electroless plating bath for coating silver metal is also described. A method for autocatalytic plating of silver metal directly onto a silicon surface without the need for an intervening layer of metal is also disclosed. The deposits of silver obtained are uniform, non-porous and have electrical properties. The technique can be applied for different processes and bath formulations i.e. different metals, complexing agents and reducing agents.

### TECHNICAL FIELD

The present invention relates to an improved method for autocatalytic electroless deposition of metals on various substrates and applications. In particular the invention relates to a novel process for stabilization of processes for autocatalytic electroless deposition of metals, such as silver, and copper, resulting in uniform layers with excellent electrical performance. Typical applications are conductive and environmental protective layers on microwave components, solderable and bondable surfaces on PWB's and wafers, the plating of solar cells, catalytic beds and interconnects for multi-layer three-dimensional silicon architecture in multi-wafer stacks.

### BACKGROUND OF THE INVENTION

There are several well known technologies for the plating of metals, such as electroplating, immersion plating and autocatalytic electroless plating. The three methods outlined below have varying requirements as regards bath composition and substrate type, and produce coatings with various properties.

Electroplating involves the formation of an electrolytic cell wherein a plating metal represents an anode and a substrate represents a cathode, and an external electrical charge is supplied to the cell in order to coat the substrate.

Immersion (displacement) plating is the deposition of a metallic coating on a base metal from a solution that contains the coating metal. A first metal ion is displaced by a second metal ion that has a lower oxidation potential than the displaced first metal ion. In immersion plating, reducing agents are not required to reduce the metal ions to metal, as the base metal acts as a reducing agent. The thickness of deposits obtained by immersion plating is limited because deposition stops when the entire surface of the base metal is coated. U.S. Pat. No. 2,842,561 and US 2002/0064676 are examples of displacement plating processes wherein the metal is plated on to the substrate without the use of a reducing agent.

Autocatalytic electroless plating refers to the autocatalytic or chemical reduction of metal ions plated to a base substrate. The process differs from immersion plating in that deposition of the metal is autocatalytic or continuous. One attractive benefit of autocatalytic electroless plating over electroplating is the ability to plate a substantially uniform metallic coating onto substrate having an irregular shape. Electroless coatings are also virtually nonporous, which allows for grater corrosion resistance than electroplated substrates. In general, electroless plating baths consist of metal salts, complexing agents, reducing agents and different additives for increasing brightness, stability and deposition rate. Under autocatalytic electroless plating, the metal salt is reduced in situ by the reducing agent and the metal thus formed coats the substrate.

The present invention concerns autocatalytic electroless plating. There are several known formulations for autocatalytic electroless silver deposition based on different silver salts, complexing agents, reducing agents and additives.

For example reducing agents such as glucamines (EP 0 292 087 A2) and potassium boron hydride (JP55044540) are used. Cyanide is a common complexing agent; a less toxic alternative is ammonia. Solutions containing silver nitrate and ammonia (U.S. Pat. No. 6,387,542 B1), can however be explosive when dried.

The use of stabilisers in electroless gold baths is known. For example, U.S. Pat. No. 5,803,957 describes an electroless gold bath which includes poly(vinylpolypyrrolidone), PVPP, as a stabiliser, while U.S. Pat. No. 5,364,460 describes a gold bath containing a non-ionic surfactant. U.S. Pat. No. 4,293,591 discloses a catalytic electroless plating system which uses metal colloids as the active species.

However, electroless gold processes are rather sensitive to operate, and the pre-treatment of the substrate is critical. Additionally, there are many problems associated with the formation of “black pads” between gold and nickel. Furthermore, gold is extremely expensive.

It would be desirable to be able to produce metal coatings on substrates which have the benefits of high optical reflectivity and electrical conductivity, but without the disadvantages associated with gold.

Fundamental problems with electroless silver plating processes are the stability of the baths and the properties of the deposited layers. An unstable bath can rapidly decompose—i.e. all silver will plate out of the bath in a few minutes. The electrical properties of the deposited layers will be affected if there is a co-deposition of additives. For example a very bright surface can be completely useless for microwave applications if the surface conductivity not is good enough, as a result of co-deposition of additives as brighteners and stabilizers. On the other hand, if the level of additives is reduced, the bath stability can decrease and the surface roughness can increase. Silver is also known to the metal most prone to dendrite formation. Dendrite formation as a result from electrochemical migration, is very critical in PWB applications and often a major reason to choose an alternative to silver.

### SUMMARY OF THE INVENTION

The present invention provides a method for plating a substrate with a metal using an autocatalytic electroless plating bath, said bath comprising a surfactant, preferably a substituted alkylene oxide compound, said method comprising contacting the substrate with the bath, wherein the bath is operated above its cloud point temperature such that at least two phases are present in the bath.

The invention further provides an autocatalytic electroless silver plating bath comprising: (i) an aqueous solution of a silver salt; (ii) substituted alkylene oxide compounds; and (iii) boric acid.

Herein is also described a method for plating silver metal directly onto a silicon surface without the need for an intervening layer of metal, the method comprising: etching the surface of the silicon, immersion of the silicon surface into the bath described above; allowing the silicon surface to be coated with silver metal; and removing the silver-coated silicon surface from the bath.

### DESCRIPTION OF PREFERRED EMBODIMENTS

The invention provides a novel technique for stabilizing autocatalytic electroless processes in general and silver plating processes in particular. The deposits of silver are uniform, non-porous and have excellent electrical properties. Furthermore the deposits shows excellent resistance to electrochemical migration and dendrite formation, especially when the surface is chemical passivated. The technique can be applied for different processes and bath formulations i.e. different metals, complexing agents and reducing agents.

The stabilizing technique is based on a multi-phase plating process and uses non-ionic (e.g. alkylene oxide) surfactants or a combination of such surfactants and polyalkylene oxide compounds or a combination of such surfactant with acids or a combination of surfactant/polyalkylene oxide compounds and acids. In a preferred form, the polyalkylene oxide compound contains at least two alkoxy groups. The traditional function of a surfactant in a plating bath is to improve wettability. The surfactant activity and performance are usually greatest just below the cloud point. If the temperature is raised over the cloud point the surfactant drops out of the solution, i.e. two different phases coexist in the plating bath and the solution will become turbid (cloudy). Predominant practise in the field is therefore to operate plating baths below the cloud point of the solution in the bath—a homogeneous (single-phase) bath. US 2004/038073 and U.S. Pat. No. 6,235,093 are examples of conventional electroless plating processes. However, it has surprisingly been found that operation of such a plating bath above the cloud point of the solution in the bath leads to controlled deposition of the metal, reduced decomposition of the bath, increased brightness of the deposited metal and the ability to provide high plating speed at very low concentrations of metal. If a dispersion of a polyalkylene oxide, for example polyethyleneglycol or blockpolymers of polyethyleneoxide and polypropyleneoxide is also present, there will be at least three different phases in the plating bath. The use of such components in a multiphase process will give a significant increase in bath stability as a result of both chemical and physical interaction with the plating process. It is also possible to lower the cloud point by using an acid. Furthermore, it is also found that the use of acids improves covering and reduces overplating, on substrates with narrow grids.

In a first embodiment, the invention relates to a method for plating a substrate with a metal using an autocatalytic electroless plating bath, said bath comprising a surfactant, said method comprising contacting the substrate with the bath, wherein the bath is operated above the cloud point temperature of the surfactant such that at least two phases are present in the bath. Preferably, two phases are present in the bath. It may be the case that the bath has a cloud point which is below the surroundings, so that the temperature of the bath is always above the cloud point of the surfactant. Alternatively, the bath can be kept warm while not in use, which minimizes unwanted decomposition/deposition. Both of these options allow the bath to be kept in “stand-by” for long periods. Preferred baths have cloud points below 20° C., such as below 40° C., below 50° C. or below 70° C. Preferably, the bath is operated at a temperature which is a few degrees (e.g. 2-5° C.) above the cloud point temperatures of the bath. Preferred operating temperatures of the bath are at least 20° C., more preferably at least 30° C. and even more preferably at least 50° C.

Different metals may be deposited using this method. Particularly, the metal is selected from the group consisting of Ag, Cu, Pd and Co. Preferably, the metal is silver or copper, and even more preferably, the metal is silver. The metal may be present in a concentration of between 0.05-50 g/l, preferably 0.3-10 g/l, more preferably 0.4-2.0 g/l. In the method described, the autocatalytic electroless plating bath may be operated at a temperature between 20° C. and 100° C., preferably between 23-85° C., more preferably between 50-80° C.

According to the method described, the surfactant to be used in the bath is preferably non-ionic, and is usually present in a concentration ranging from 0.01 g/l to 10 g/l inclusive, preferably from 0.10 g/l to 1.0 g/l inclusive, more preferably from 0.10 g/l to 0.30 g/l inclusive. In one embodiment, the surfactant comprises ethylene glycol monomer units. In a preferred embodiment, the surfactant is nonylphenol ethoxylate. Alternatively, the surfactant can be Ethylan® 1008W, Ethylan® HB1, Ethylan® D253, Ethylan® CO35, Ethylan® CPG660, Ethylan® 1005, Ethylan® CD127 P/N, Ethylan® A4, Ethylan® BCD42 or any of the non-ionic surfactants sold under the trademark Berol®, all of which are produced by the Akzo Nobel company.

The autocatalytic electroless plating bath used in the above-described method may additionally comprise certain additives, such as polyalkylene oxide compounds, polymers and acids.

The polymers to be used in the bath are preferably oxyethylene-based, (homo, graft and block copolymers), and more preferably polyethyleneglycol with an average molecular weight between 100 and 4000. The polymers are usually present in a concentration ranging from 0.01 g/l to 10.0 g/l inclusive, preferably from 0.01 g/l to 1.0 g/l inclusive, more preferably from 0.10 g/l to 1.0 g/l. Organic acids, for example amino acids as well as inorganic acids can be used as additives. In a particular embodiment boric acid is used. The acids are usually present in a concentration ranging from 0.1 g/l to 300 g/l.

Another type of additive is a pH-increasing additive. This is a base, such as e.g. a metal hydroxide salt. The base helps to keep the pH of the plating bath between 9.5 and 13, preferably between 10 and 12.

A reducing agent is present in the autocatalytic electroless plating bath according to the method of the present invention. Such a reducing agent may be selected from the group comprising: dextrose, glyoxal, Rochelle salts, mixtures of Rochelle salts and crystallized sugar, inverted sugar, cobalt ion, hydrides, glucamines, metal hydride salts, hydrazine, hydrazine sulfate, dimethylamine borane, diethylamine borane, triethylamine borane, formaldehyde, hypophosphite, gluconates, polyhydric alcohols, aldonic acid, aldonic lactone and sulfides.

An autocatalytic electroless plating bath for use in the method according to the present invention may contain one or more complexing agents. The complexing agent may be selected from the group comprising EDTA, Rochelle's salt, citric acid, sodium citrate, succinic acid, proprionic acid, glycolic acid, sodium acetate, lactic acid, sodium pyrophophate, pyridium-3-sulfonic acid, potassium tartrate, Quadrol, sodium phosphate, potassium citrate, sodium borate, sodium cyanide, potassium cyanide, triethylenetetraamine and methylamine.

In a second embodiment, the present invention also relates to an autocatalytic electroless silver plating bath comprising: i) an aqueous solution of a silver salt; ii) a substituted alkylene oxide compound and iii) boric acid. Boric acid has been found to enhance the stability of such baths. Such a bath may be used in the method as described above. In such a bath, the metal may be present in a concentration of between 0.05-5 g/l, preferably 0.3-3.0 g/l, more preferably 0.4-2.0 g/l; the substituted alkylene oxide compound may be present in a concentration ranging from 0.01 g/l to 10 g/l inclusive, preferably from 0.10 g/l to 1.0 g/l inclusive, more preferably from 0.10 g/l to 0.30 g/l inclusive.

The autocatalytic electroless plating bath may additionally comprise polyethylene glycol with a molecular weight from 100-4000 in which part of the polymer is soluble in the aqueous solution. Such polyethylene glycol may be present in a concentration of up to 10 g/l.

The autocatalytic electroless plating bath according to this embodiment may additionally comprise a base. The base may be selected from the group comprising: hydroxides of group I and II metals (such as KOH, NaOH, LiOH, Ca(OH)₂, Mg(OH)₂or organic bases). In addition, the autocatalytic electroless plating bath may additionally comprise a reducing agent. Such reducing agents can be selected from the group comprising: dextrose, glyoxal, Rochelle salts, mixtures of Rochelle salts and crystallized sugar, inverted sugar, cobalt ion, hydrides, metal hydride salts, hydrazine, hydrazine sulfate, dimethylamine borane, diethylamine borane, triethylamine borane, formaldehyde, hypophosphite, gluconates, polyhydric alcohols, aldonic acid, aldonic lactone and sulfides. Furthermore, the autocatalytic electroless plating bath may additionally comprise a complexing agent. Such a complexing agent may be selected from the group comprising EDTA, Rochelle's salt, citric acid, sodium citrate, succinic acid, proprionic acid, glycolic acid, sodium acetate, lactic acid, sodium pyrophophate, pyridium-3-sulfonic acid, potassium tartrate, Quadrol, sodium phosphate, potassium citrate, sodium borate, sodium cyanide, potassium cyanide, triethylenetetraamine and methylamine. In a preferred embodiment, the substituted alkylene oxide compound is nonylphenol ethoxylate. Alternatively, the surfactant can be Ethylan® 1008W, Ethylan® HB1, Ethylan® D253, Ethylan® CO35, Ethylan® CPG660, Ethylan® 1005, Ethylan® CD127 P/N, Ethylan® A4, Ethylan® BCD42 or any of the non-ionic surfactants sold under the trademark Berol®, all of which are produced by the Akzo Nobel company.

Furthermore, the autocatalytic electroless plating bath may additionally comprise an acid. Such an acid may be organic acid, for example an amino acid, or an inorganic acid.

Typically, the silver layers obtained by use of such a bath are semi-bright to bright.

In one embodiment, the method additionally comprises the step of plating a layer of gold through immersion plating on top of the layer of the metal which is deposited first. This is particularly of interest in the case where the metal deposited first is silver. The invention further relates to an object coated according to this specific method (i.e. first autocatalytically coated with a layer of silver and then immersion plating a layer of gold on top of the silver layer). Traditionally, gold is coated on top of nickel (ENIG-process). For the ENIG process the thickness of the gold layer is typically min 0.05-0.1 microns, to prevent oxidation of the nickel surface. For application on autocatalytic silver, there is no need for oxidation prevention, so we can use much thinner layer, i.e. typically 0.01 micron will be enough. This provides an important cost reducing factor.

It is highly desirable to be able to plate silver onto silicon. However, direct deposition of silver metal onto silicon has proved difficult, and the silicon surface often requires preparation, such as applying a first coat seed layer of Sn, Pd, Cu or Ni, or alternatively immersion silver. Silver-plating directly onto silicon finds application in solar cells (e.g. plating on buried contact solar cells, evaporated Ti—Pd—Ag-fingers, thin printed front-side fingers, fired Ag-paste, BSF (back surface field)), in catalytic beds, in wafers, ( interconnects for multi-layer three-dimensional silicon architecture in multi-wafer stacks etc. ) PWB's (e.g. plating of solderable, lead-free and bondable surfaces) and in microwave components (e.g. plating of metallic, plastic and ceramic components). The electroless plating bath and method described according to the present invention can be used to deposit silver metal directly onto silicon without any intermediate layers of immersion silver, tin, palladium, copper or nickel.

It has been surprisingly found that silver deposition, according to the invention, can start directly on an etched silicon surface without any intermediate seed layers. The adhesion is good and the process has the ability to plate extremely fine lines of silicon. Examples of applications are etched patterns on silicon wafers or buried contacts in solar cells.

In a third embodiment, therefore, the present invention relates to a method for autocatalytic plating of silver metal directly onto a silicon surface without the need for an intervening layer of metal, the method comprising:

i. etching of the silicon surface.

ii. immersion of the silicon surface into the bath described above;

iii. allowing the silicon surface to be coated with silver metal; and

iiii. removing the silver-coated silicon surface from the bath.

The etching step is carried out according to any known method. Generally, etching takes place by immersion of the silicon surface in a bath containing HF, usually in the form of NH₄F.HF.

The plating method according to the present invention can be used as a general, one-step process on top of copper to provide bondable and solderable surfaces.

The examples given below are mean to illustrate the present invention. Hence, the invention should not be considered as limited to the given examples, but rather by the scope of the claims.

### EXAMPLES

A plating bath according to the present invention generally has the following composition:

| | | |
|---|---|---|
| Ag, Cu, Pd or Co metal | 0.5-5 | g/l |
| Surfactant | 0.01-10 | g/l |
| Polyethylene glycol (optional) | <0.2 | g/l. |

Plating is carried out above the cloud-point of the bath, at a temperature between 20° C. and 100° C., preferably between 23-85° C., more preferably between 50-80° C., and the pH of the plating bath lies between 9.5 and 13.

### Example 1

A Pd-activated polymeric component was subjected to electroless copper plating by using a plating bath with the following composition/condition:

| | | |
|---|---|---|
| EDTA | 13.6 | g/l |
| NaOH | 13.3 | g/l |
| CuSO₄x5H₂O | 7.0 | g/l |
| Nonylphenol ethoxylate | 0.5 | g/l |
| PEG (4000) | 1 | g/l |
| CH₂O | 11 | g/l |
| Temperature | 57° | C. |

| | |
|---|---|
| Agitation | air |

The plating was performed over the cloud point and the plating rate was approximately 1 micron/hour. The component was completely covered by a smooth and non-porous copper surface.

### Example 2

Additional polyalkylene oxide compounds were added to a standard organic borane bath, as formulated by Pearlstein and Weightman*, in the 1970s which is well known for spontaneous bath decomposition:

| | | |
|---|---|---|
| NaAg(CN)₂ | 1.83 | g/l |
| NaCN | 1.0 | g/l |
| NaOH | 0.75 | g/l |
| DMAB | 2.0 | g/l |
| Polyalkylene oxid compounds | 0.4 | g/l |

* see F. Pearlstein and R.F. Weightman “Electroless Deposition of Silver Using Dimethylamine Boran” Plating, Vol. 61, Feb. 1974, p.154-157

A copper plate was subjected to electroless silver plating, in a 200 liter bath, which had been set up 8 months previously. During the period of inactivity, the bath was at room temperature, agitated and the liquid level was controlled automatically. The bath was still stable and it had kept its autocatalytic properties. The composition of the bath was the same as that used in Example 2. The plating conditions were:

| Temperature | 60° C. |
|---|---|
| pH | 11.6 |

The plating was performed over the cloud point (55° C.). The deposition rate was ca. 1.5 microns/hour and the silver layer was smooth and semi-bright.

### Conductivity Measurements

There are different methods for measurements of conductivity. For example, the conductivity can be measured directly, by using an eddy current instrument, or the conductivity can be calculated from measured reflection coefficients for plated microwave cavities. In these examples, conductivity was calculated from measured reflection coefficients.

| Concentration of stabilizer (g/l | conductivity (S/mm) |
|---|---|
| 0.2 | 6.2 × 10⁻⁴ |
| 1.0 | 3.6 × 10⁻⁴ |

1. A method for plating a substrate with a metal using an autocatalytic electroless plating bath, said bath comprising a surfactant, said method comprising contacting the substrate with the bath, wherein-the bath is operated above the cloud point temperature of the solution in the bath such that at least two phases are present in the bath.

2. A method according to claim 1, wherein two phases are present in the bath.

3. A method according to claim 1, wherein the metal is selected from the group consisting of Ag, Cu, Pd and Co.

4. A method according to claim 3, wherein the metal is selected from the group consisting of Ag and Cu.

5. A method according to claim 4, wherein the metal is Ag.

6. A method according to claim 1, wherein the autocatalytic electroless plating bath is operated at a temperature between 20° C. and 100° C., preferably between 23-85° C., more preferably between 50-80° C.

7. A method according to claim 1, wherein the surfactant is present in a concentration ranging from 0.01 g/l to 10 g/l inclusive, preferably from 0.1 g/l to 1.0 g/l inclusive, more preferably from 0.1 g/l to 0.3 g/l inclusive.

8. A method according to claim 1, wherein the surfactant is non-ionic.

9. A method according to claim 8, wherein the surfactant is a substituted alkylene oxide compound.

10. A method according to claim 9, wherein the surfactant comprises ethylene glycol monomer units.

11. A method according to claim 10, wherein the surfactant is nonylphenol ethoxylate.

12. A method according to claim 1, wherein the autocatalytic electroless plating bath additionally comprises polyethylene glycol with a molecular weight from 100-4000 in which part of the polymer is soluble in the aqueous solution.

13. A method according to claim 1, wherein the autocatalytic electroless plating bath further comprises a pH-increasing additive.

14. A method according to claim 13, wherein the pH-increasing additive is a base, such as e.g. a metal hydroxide salt.

15. A method according to claim 1, wherein the pH of the plating bath lies between 9.5 and 13, preferably between 10 and 12.

16. A method according to claim 1, wherein the autocatalytic electroless plating bath further comprises an acid.

17. A method according to claim 16, wherein the acid is boronic acid.

18. A method according to claim 1, wherein the autocatalytic electroless plating bath further comprises a reducing agent.

19. A method according to claim 18, wherein the reducing agent is selected from the group comprising: hydrides and metal hydride salts of boron and aluminium, glucamines, dextrose, glyoxal, Rochelle salts, mixtures of Rochelle salts and crystallized sugar, inverted sugar, cobalt ion, hydrides, metal hydride salts, hydrazine, hydrazine sulfate, dimethylamine borane, diethylamine borane, triethylamine borane, formaldehyde, hypophosphite, gluconates, polyhydric alcohols, aldonic acid, aldonic lactone and sulfides.

20. A method according to claim 1, wherein the metal is present in a concentration of between 0.05-5 g/l, preferably 0.3-3 g/l, more preferably 0.4-2.0 g/l.

21. A method according to claim 1, additionally comprising the step of plating a layer of gold through immersion plating on top of the layer of the metal of claim 1.

22. A method according to claim 21, in which the metal of claim 1 is silver.

23. An object coated according to the method of claim 21.

24. A method according to claim 1, wherein the substrate is a silicon surface and the metal is silver.

25. A method according to claim 24, wherein no intermediate layer is present between the silicon surface and the silver.

26. An autocatalytic electroless silver plating bath comprising:
i. an aqueous solution of a silver salt; and
ii. a substituted alkylene oxide compound
iii. boric acid.

27. An autocatalytic electroless silver plating bath according to claim 26, wherein a metal is present in a concentration of between 0.5-5 g/l, preferably 0.3-3 g/l, more preferably 0.4-2 g/l.

28. An autocatalytic electroless plating bath according to claim 26, wherein the substituted alkylene oxide compound is nonylphenol oxylate.

29. An autocatalytic electroless plating bath according to claim 26, wherein the substituted alkylene oxide compound is present in a concentration ranging from 0.01 g/l to 10 g/l inclusive, preferably from 0.1 g/l to 1 g/l inclusive, more preferably from 0.1 g/l to 0.3 g/l inclusive.

30. An autocatalytic electroless plating bath according to claim 26, additionally comprising polyethylene glycol with a molecular weight from 100-4000 in which part of the polymer is soluble in the aqueous solution.

31. An autocatalytic electroless plating bath according to claim 26, wherein the polyethylene glycol is present in a concentration of up to 0.2 g/l.

32. An autocatalytic electroless plating bath according to claim 26, additionally comprising a base.

33. An autocatalytic electroless plating bath according to claim 26, wherein the base is selected from the group comprising: hydroxides of group I and 11 metals, and organic bases.

34. An autocatalytic electroless plating bath according to claim 26, additionally comprising a reducing agent.

35. An autocatalytic electroless plating bath according to claim 34, wherein the reducing agent is selected from the group comprising: hydrides and metal hydride salts of boron and aluminium, glucamines, dextrose, glyoxal, Rochelle salts, mixtures of Rochelle salts and crystallized sugar, inverted sugar, cobalt ion, hydrides, metal hydride salts, hydrazine, hydrazine sulfate, dimethylamine borane, diethylamine borane, triethylamine borane, formaldehyde, hypophosphite, gluconates, polyhydric alcohols, aldonic acid, aldonic lactone and sulfides.

36. An autocatalytic electroless plating bath according to claim 26, additionally comprising a complexing agent.

37. An autocatalytic electroless plating bath according to claim 36, wherein the complexing agent is selected from the group comprising EDTA, Rochelle's salt, citric acid, sodium citrate, succinic acid, proprionic acid, glycolic acid, sodium acetate, lactic acid, sodium pyrophophate, pyridium-3-sulfonic acid, potassium tartrate, Quadrol, sodium phosphate, potassium citrate, sodium borate sodium cyanide, potassium cyanide, triethylenetetraamine and methylamine.

38. A method for autocatalytic plating of silver metal directly onto a silicon surface without the need for an intervening layer of metal, the method comprising:
i. etching of the silicon surface.
ii. immersion of the silicon surface into the bath of claim 26;
iii. allowing the silicon surface to be coated with silver metal; and
iiii. removing the silver-coated silicon surface from the bath.
